(19) United States
(12) Patent Application Publication
(10) Pub. No.: US 2018/0236801 A1
(43) Pub. Date: Aug. 23, 2018

(54) Method for Printing and Transfer Onto a Food Item

(71) Applicant: 9083-8319 QUÉBEC INC. FASRS SIGNATURE PASQUIER, Sainte-Famille (CA)

(72) Inventors: Robert PAQUET, Sainte-Famille (CA); Francis PAQUET, Sainte-Foy (CA); Michelle BEAULIEU, Sainte-Famille (CA)

(21) Appl. No.: 15/920,239

(22) Filed: Mar. 13, 2018

Related U.S. Application Data
(63) Continuation of application No. PCT/CA2016/051035, filed on Sep. 1, 2016.
(60) Provisional application No. 62/218,018, filed on Sep. 14, 2015.

(51) Int. Cl. B41M 5/025; B41M 5/035; C09D 11/08; C09D 11/06; A23P 20/10; A23P 20/15; A21D 13/47

(52) U.S. Cl. CPC B41M 5/0256; B41M 5/0356; C09D 11/08; A21D 13/47; A23P 20/11; A23P 20/15; C09D 11/06

(57) ABSTRACT

The present invention relates to a method for transferring the print of a logo (i.e. an image or text) onto a food item, notably a bakery or pastry item, butcher's products and cooked pork meats or a solid dairy product, and to an edible ink composition and a carrier medium for this purpose.

### SCOPE OF THE INVENTION

The present invention relates to a method for transferring the print of a logo (i.e. an image or text) onto food items, notably bakery and pastry items (e.g. bread, pastries made with sweetened dough, etc.), butcher's products and cooked pork meats (sausage, terrine, etc.), or on solid dairy products (e.g. butter, cheeses, etc.), and to an edible ink composition and a carrier medium for carrying out this method.

### BACKGROUND OF THE INVENTION

The modern mode of consumption as well as the increasing use of marketing on foodstuffs and food packaging creates a strong demand for foodstuffs bearing various logos, patterns and phrases. Baker's shops, supermarkets and other food distributors have adapted to demand by using increasingly sophisticated printing techniques for putting images on foodstuffs.

Application EP 1 413 206 describes tattooing for children, where the carrier medium and the ink are edible, the carrier medium consisting of gum acacia, corn starch, microcrystalline cellulose, etc.

Document WO 2002/085995 describes an edible ink usable in a lithography process. Thus, a first color of edible ink is vaporized through a stencil onto a carrier medium, normally a sugar coating or film, to form the first layer of the image on the surface of this carrier medium. The step is repeated, one stencil/color at a time, until the multi-color image is completed on the surface of the carrier medium.

Using another method, a first color of edible ink can be applied on one of the automatically transferable pads of a printer. The pad is then compressed against a hard surface, of sugar coating on a cake, to form a first layer of the desired image. The step is then repeated, one color at a time, until the multi-color image is completed on the surface of the carrier medium.

Otherwise, the illustration may be digitized and the generated file is uploaded to an inkjet printer, at least one of the cartridges of which is filled with edible ink. The inkjet printer then applies the first layer of ink of the desired image on the surface of a carrier medium.

These techniques are much more efficient than a method of decorating by hand. They have made high-quality decoration possible for a large number of foodstuffs available on the market. However, these techniques are still relatively slow and are unsuitable for mass production of decorated foodstuffs.

Application EP 0 673 206 describes a method for transferring a logo from baking paper to a bakery item, employing the bread baking cycle. Now, this technique, although useful, employs printed labels, for which the quality of transfer is not optimal, since transfer, effected during cooking, is affected by the production of water vapor between the bread and the carrier medium, thus giving an image of variable quality.

For its part, the present invention discloses a method for transferring print and an edible ink, in order to transfer logos onto foodstuffs having a moist surface, such as bakery/pastry items, butcher's products and cooked meats, which may or may not require cooking, or else solid dairy products. Said transfer is effected using a hot or cold thermal cycle, either before, during or after cooking the item in question. Surprisingly, this method of printing results in a print quality so accurate that it even adapts perfectly to the irregularities of the food item.

### SUMMARY OF THE INVENTION

According to a first aspect, the invention supplies an edible ink, comprising: water, glycerin, oil, flour, microcrystalline cellulose, starch and calcium carbonate. This ink allows not only efficient, highly reproducible transfer onto various food items, but also allows both hot and cold transfer. In addition, the composition of the ink was developed to provide continuous high volume printing on a screen printing machine, making it possible for this method to be applied on a large scale on food items produced industrially.

In particular, this ink comprises: about 25% to 50% of water, about 5% to 15% of glycerin, about 2% to 6% of vegetable oil, about 5% to 15% of flour, about 2.5% to 5% of microcrystalline cellulose, about 5% to 10% of starch, and about 0.7% to 1.3% of calcium carbonate.

According to a second aspect, the invention supplies a method comprising the following steps: depositing, on a flexible carrier medium, a reproduction of a desired logo by means of a pasty composition based on flour and water, called “ink or paste”, using this carrier medium, this logo reproduction is glued on the food preparation, which then undergoes a thermal cycle for effecting transfer of the paste; and finally the carrier medium is removed prior to packaging or consumption of the food preparation.

This method makes it possible to label and identify food preparations by transferring a logo accurately and permanently, by means of the edible ink composition. This method also makes it possible to obtain a food composition without altering the surface, texture (in the hand and/or in the mouth; and/or taste following print transfer.

According to another particular aspect, the invention supplies a method for making a food item printed with a logo, comprising the following steps: a) obtaining a flexible, porous carrier medium, printed with a logo on at least one face using an edible ink that can be transferred onto a moist food surface; b) gluing the carrier medium to the surface; c) applying a hot thermal cycle to the carrier medium affixed to the surface; and d) removing the carrier medium from the surface.

Surprisingly, the porosity or perforation of the carrier medium allows transfer to be effected without imperfections, in hot or cold thermal transfer. The quality of transfer is based on the porosity of the carrier medium, as this allows: a) the paper to follow the shape and adhere to the surface of the dough, which eliminates marks from the paper on the dough and holes in the bread; b) heat to circulate under the paper, which gives uniform coloration of the bread and transfer in a short time; c) the gases (air bubbles) that form during baking to escape, so that the transfer is identical to that which is on the carrier medium. All these advantages give high print quality, constancy, controlled quality and very few rejects for food items produced on an industrial scale.

According to another particular aspect, the invention supplies a method for transferring a logo onto a food item, said method comprising the following steps: a) printing the logo with an edible ink on at least one face of a flexible, porous carrier medium and leaving the ink to dry on the carrier medium; b) depositing the printed face of the carrier medium on a moist food surface; c) applying a hot thermal cycle to the carrier medium deposited on the surface; and d) removing the carrier medium from the surface, onto which the logo has now been transferred.

According to an additional aspect of the invention, a printing carrier medium is described for printing a logo on a moist food surface, the carrier medium essentially consisting of perforated film/paper, at least one face of the film/paper being suitable for printing with an edible ink, and for transferring the ink onto the food surface during a thermal cycle.

According to another aspect, the invention supplies a method for making a carrier medium for logo printing on a food item, comprising the following steps: a) perforating a baking film/paper: b) printing a logo with an edible ink on at least one face of the perforated film/paper; and drying the ink.

According to an additional aspect of the invention, an edible composition is described comprising: a food item, cooked or uncooked, printed with a logo, the item having been printed by thermal transfer of the logo previously printed on a carrier medium.

Moreover, according to another aspect of the invention, a humidifier module is described for a screen printing machine suitable for printing a porous flexible carrier medium, said module comprising: an ultrasonic humidifier as well as a perforated-nozzle pipe system that makes it possible to create a controlled humid environment in the printing zone. This makes it possible to maintain the necessary ink viscosity for continuous printing.

### DETAILED DESCRIPTION OF THE INVENTION

The particular features and advantages of the subject matter of the present patent application will be demonstrated in a detailed, structured description, accompanied by figures. When carried out as intended, the subject matter disclosed and the claims of the present patent application may undergo various changes, which do not affect the scope of the claims in any way. Thus, the figures and the descriptions only serve as examples for establishing the scope of the subject matter of the present patent application, and they are not to be interpreted as limitations to its possible uses.

### DESCRIPTION OF THE FIGURES

FIG. 1 shows the general appearance of various bakery items (breads) with the various prints according to the method of the invention;

FIG. 2A shows a screen printing machine comprising an integrated humidifying system for carrying out the method of the present invention.

FIG. 2B shows the humidifying system detached from the printing machine.

FIG. 3 shows various types of baking paper used as carrier medium for determining which is the most suitable for transfer.

FIG. 4A shows the result of a transfer with unperforated paper.

FIG. 4B shows the result of a transfer with perforated paper.

FIG. 5 shows a prototype of a cylinder with needles for making perforations in the baking paper (carrier medium), before or after printing the ink.

FIG. 6 illustrates the method of applying the carrier medium on bread dough before baking: transfer is effected in a few seconds after a cold thermal cycle (deep freezing) or in a few hours after a cold thermal cycle (freezer) and the carrier medium is removed before cooking.

FIGS. 7A-C illustrate the method of applying the carrier medium on loaves by a thermal cycle after baking: the carrier medium is deposited on the cooked dough moistened with milk (A); pressure is applied using a heated weight (such as a hot cast-iron plate) in order to create a hot thermal cycle (B, C).

FIGS. 8A-C illustrate the method of applying the carrier medium on loaves by a thermal cycle during baking: after shaping, and removal from the oven, the carrier medium is placed on dough with or without yeast, moistened and sticky before cooking (A, B) ; the carrier medium is then removed at the end of baking in the oven (C).

FIGS. 9A-C present alternatives of the method of printing according to the invention on various pastry items (salted dough (A) or sugared dough (B, C), where the shaped dough is deposited on the carrier medium (A, B) or the carrier medium is deposited around the shaped dough (C).

FIGS. 10 show examples of cold transfer: (A) on a sugared dough; (B, C) on a sausage; and (D) on smoked sausage; (E) on cheese, and (F) on butter.

FIG. 11 shows examples of hot transfers, in the frying pan, on sausages, on fresh or smoked sausage.

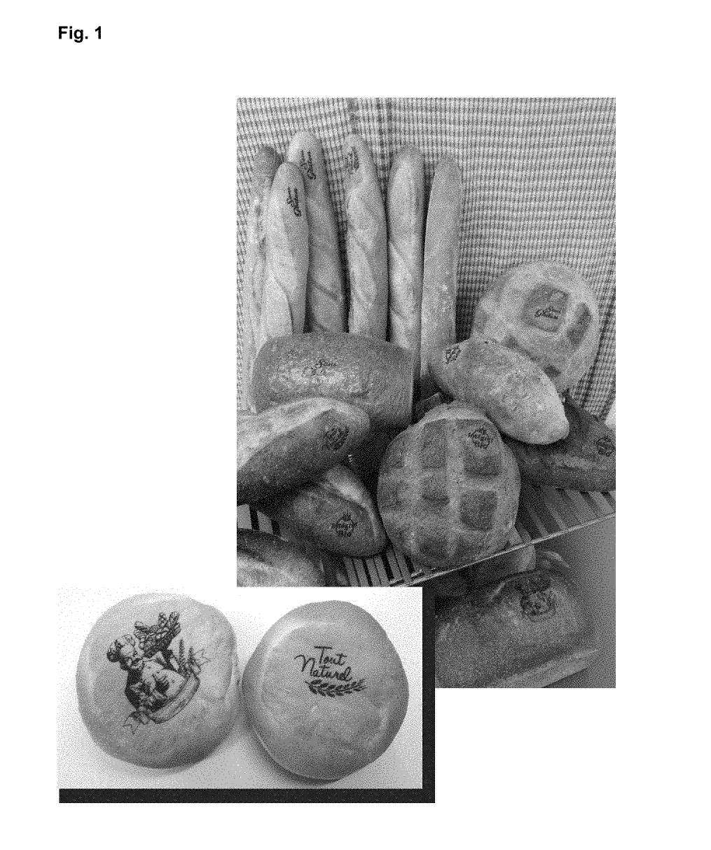

### ABBREVIATIONS AND DEFINITIONS

### Definitions

The word “about” or “approximately” as used in the present patent application refers to a margin of error of +or −10% of the associated number. For reasons of accuracy, the word “about” when used for example in conjunction with 90%, signifies 90% +/−9%, i.e. from 81% to 99%. More precisely, the word “about” refers to + or −5% of the associated number when, for example: 90%, signifies 90% +/−4.5%, i.e. from 86.5% to 94.5%.

As used in the present patent application, the words “a”, “and” and “the” used in singular number also include a plurality of elements depending on the context, unless it is possible to deduce otherwise. Thus, for example, the expression “a dough” is to be understood as including a plurality of doughs and the expression “the dough” as including one or more other doughs, or the equivalent of a dough for a person skilled in the art. All the technical and scientific terms used in the present application are to be understood in the way that they are generally used by a person skilled in the art connected with the invention, unless stated otherwise.

As used in this definition and in the claims, the words “comprising” (as well as any other derived form such as “comprises” and “comprise”), “having” (as well as any other derived form such as “has” and “have”), “including” (as well as any other derived form such as “includes” and “include”) or “containing” (as well as any other derived form such as “contains” and “contain”) are inclusive or unlimited, and do not exclude additional elements or steps that are not mentioned.

### DETAILED DESCRIPTION OF PARTICULAR EMBODIMENTS

### Edible Ink

According to a first particular embodiment, the invention comprises an edible ink, transferable to a moist surface of a food item, said ink comprising about: from 30% to 45% of water; from 8% to 12% of glycerin; from 3% to 6% of vegetable oil; from 8% to 12% of flour; from 3% to 4.5% of microcrystalline cellulose; from 6% to 8% of starch; and from 0.8% to 1.2% of calcium carbonate. In particular, the calcium carbonate added to this recipe has the aim of establishing a stable viscosity to allow continuous screen printing. More particularly, the calcium carbonate serves as a binder and moisture collector for the ink.

More particularly, the ink comprises about: from 30% to 45% of water; from 8% to 12% of glycerin; from 3% to 4.5% of canola oil; from 1 to 2% of coconut oil; from 8% to 12% of tapioca flour; from 3% to 4.5% of microcrystalline cellulose; from 6% to 8% of rice starch; and from 0.8% to 1.2% of calcium carbonate.

Optionally, the edible ink also comprises: from 7% to 10% of Trimoline®; from 1% to 2% of polysorbate 60/80; from 0.1% to 0.3% of soybean lecithin; from 4% to 5.5% of solid corn syrup; from 2% to 3% of confectioner's sugar; from 0.01% to 0.05% of gum acacia; from 0.2% to 0.4% of modified starch; from 0.2% to 0.4% of citric acid; from 0.05% to 0.15% of potassium sorbate; from 0.2% to 0.3% of alginate; from 0.8% to 1.2% of milk protein; and from 5% to 7% of food dye.

According to a particular embodiment, the edible ink comprises about: 37.5% of water; 8.3% of Trimoline®; 9.4% of glycerin; 1.8% of potassium polysorbate; 3.7% of canola oil; 1.8% of coconut oil; 0.2% of soybean lecithin; 10.2% of tapioca flour; 4.6% of solid corn syrup; 2.8% of confectioner's sugar; 3.7% of microcrystalline cellulose; 0.05% of gum acacia; 0.5% of modified starch; 0.5% of citric acid; 0.01% of potassium sorbate; 0.5% of alginate; 7% of rice starch; 1% of calcium carbonate; 0.1% of milk protein; and 6% of food dye.

### Printing Process

According to a second aspect, the invention comprises a method for transferring a print onto a food item comprising at least one moist surface, comprising the following steps: a) obtaining a flexible carrier medium, printed on at least one side with an edible ink and transferable to the moist surface; b) gluing the carrier medium to the surface; c) subjecting the carrier medium affixed to the surface to a thermal cycle; and d) peeling the carrier medium.

According to another aspect, the invention comprises a method for transferring a logo onto a food item, said method comprising the following steps: a) printing the logo with an edible ink on at least one face of a carrier medium and leaving the ink to dry on the carrier medium; b) depositing the printed face of the carrier medium on a moist food surface; c) subjecting the carrier medium on the surface to a thermal cycle; and d) peeling the carrier medium.

According to particular embodiments of the method or of the process described above, the thermal cycle is carried out hot or cold, with or without cooking of the food item. In the case of a food that requires cooking, the thermal cycle may be carried out before, during or after cooking.

### Thermal Cycles

The thermal cycle is carried out while the carrier medium and the ink are at room temperature and the food item is cold or hot, thus creating a thermal gradient between the item and the ink, causing transfer.

### Cold Cycle

In the case of a cold thermal cycle, the thermal cycle may be carried out while the item is in the refrigerator, in the freezer or in the deep freeze, or else immediately after being taken out, while it is still cold.

Thus, in particular, the cold thermal cycle may carried out before or after cooking, if the item requires said cooking.

Before cooking: the cold thermal cycle is carried out according to the following steps: the printing carrier medium is deposited on the moistened food item after shaping (for example dough with or without yeast) and it is subjected to deep-freezing for a few minutes. The carrier medium is then removed before baking in the oven.

After cooking: the carrier medium is deposited for a few seconds on the baked dough and the whole is frozen, while ink transfer takes place. The carrier medium is then removed.

Alternatively, the carrier medium is deposited before freezing and remains affixed in the freezer for some hours, while ink transfer takes place. The carrier medium is then removed before baking in the oven.

Alternatively, the food item is taken out of the refrigerator, and the printed carrier medium is affixed to it while the item is still cold. Pressure is applied to the carrier medium for a few minutes, while ink transfer takes place. The carrier medium is then removed from the surface of the item.

### Hot Cycle

The hot thermal cycle may be carried out before, during or after cooking, if the latter is necessary.

The thermal cycle during cooking is carried out according to the following steps: after shaping, on removal from the oven, the printing carrier medium is deposited on moistened, sticky dough (with or without yeast), which is put in the oven. The carrier medium is then removed after baking for a few seconds, or else at the end of baking in the oven.

Otherwise, a thermal cycle may also be carried out after cooking according to the following steps: the printing carrier medium is deposited on the baked dough that has been moistened (e.g. with milk); pressure is applied using a hot weight (e.g. hot cast-iron plate).

According to another particular embodiment, the carrier medium is cut after step a), as required for the market or for marketing (industrial vs individual, etc.).

Dough with Yeast, and Shaping

In particular, when it is a yeast dough requiring raising in the oven, it is preferable to affix the printing carrier medium and proceed with thermal transfer after the time in the oven.

### Printing Carrier Medium

The invention also supplies a flexible, porous printing carrier medium for transferring a logo onto a moist food item, said carrier medium being suitable for printing with an edible ink, and for transferring this ink onto a moist food item during a thermal cycle, in particular a hot thermal cycle. In particular, the porous carrier medium absorbs little if any ink so as to allow transfer of the ink to the food surface, more particularly before, during or after cooking.

In particular, the printing carrier medium is cloth, a heat-resistant film or baking paper selected from: waxed paper, greaseproof paper, Teflon° film, silicone film, cheese-ripening paper, silicone-coated parchment paper or any other paper/film that can withstand thermal treatment (hot or cold) without degradation.

More particularly, the porosity of the carrier medium is intrinsic as in the case of cloth, or else is caused by perforations, thus allowing water vapor to escape during transfer. More particularly, the porosity of the carrier medium is preferably of the order of 50 to 75 cm³/15 s.

According to a particular embodiment, the invention comprises a porous flexible carrier medium for printing a logo (i.e. text or an image) on a moist food item, the carrier medium being perforated paper/film, and at least one face of the carrier medium being suitable for being printed with the logo with an edible ink that is transferable to the food item during a thermal cycle.

### Method of Making the Printed Carrier Medium

More particularly, the carrier medium is perforated after being printed with the desired logo.

According to a particular embodiment, the invention comprises a method for making a carrier medium for printing a logo on a food item comprising the following steps: a) printing the logo with an edible ink on the perforated carrier medium and drying the ink; and b) perforation of the printed carrier medium.

More particularly, the carrier medium is perforated before being printed with the desired logo.

According to a particular embodiment, the invention comprises a method for making a carrier medium for printing a logo on a food item comprising the following steps: a) perforating a flexible printing carrier medium; b) printing a logo with an edible ink on the perforated carrier medium; and drying the ink.

More particularly, porosity of the carrier medium of the order of 50 to 75 cm³/15 s can be obtained when perforations are made therein located about 1 to 6 mm apart. In particular, the perforations may form an opening with a diameter from 0.1 to 1 mm.

In particular, the carrier medium is optionally cut to a practical format (individual, 2×2, 4×4, 8×8, 12×12, etc.) with a view to use or marketing thereof.

According to a particular embodiment, the invention comprises a cylinder for perforating a printing carrier medium, said cylinder comprising needles arranged on a backing for the needles.

In particular, the needles are arranged diagonally. In particular, the backing for the needles is made of natural rubber (for example of hardness 40).

### Edible Composition

According to a particular embodiment, the invention comprises an edible composition comprising: a food item, which may or may not require cooking, printed with a logo, the item having been printed by thermal transfer of the print.

In particular, the food item is an item of butcher's products and cooked meats such as sausage, sausages, pâtés, terrines, etc.

More particularly, the food item is a bakery or pastry item, more particularly made with dough with or without yeast, raised or not raised, shaped or not shaped. Thus, the dough may be selected from flaky pastry, tart pastry, short dough, short paste, sugared dough, pie paste, puff pastry, filo pastry, baked dough, choux pastry, leavened dough, kneaded dough, brioche dough, bread dough, savarin pastry, baba mixture, leavened puff pastry, croissant dough, folded pastry, Danish leavened puff pastry, beaten dough, madeleine dough, genoise paste, Genoa bread dough, biscuit mixture, cake mixture, scone dough, muffin dough, dough for fritters, donut dough, crepe dough, turned dough, mixture for food pastes, meringue, macaroon, crème brûlée, crème catalane, fondant icing, and almond paste, etc. More particularly, the food item is a solid dairy product such as butter, cheese, ice cream, iced yoghurt, iced fudge, etc.

### Kit for Printing a Food Item

According to another particular embodiment, the invention comprises a print transfer kit for a food item comprising: a flexible, porous printing carrier medium; optionally, at least one ingredient for making an edible ink; and instructions for making the ink, printing the carrier medium and transferring said ink onto a food item using the printed carrier medium.

### Kit for Making a Printed Food Item

According to another particular embodiment, the invention comprises a kit for making a printed food item comprising: at least one ingredient for making a food item; a flexible printing carrier medium; optionally, at least one ingredient for making an edible ink; and instructions for making the ink, perforating the carrier medium, printing the carrier medium and transferring ink onto the food item using the printed carrier medium.

According to an alternative embodiment, the invention comprises a kit for making a printed food item, comprising: at least one ingredient for making a food item; a flexible, porous printing carrier medium, said carrier medium being printed on one face with a logo using edible ink; and instructions for transferring the ink onto the food item using the printed carrier medium.

In particular, the kit also comprises instructions for making the food item in question. More particularly, the food item is a cake, a loaf, a muffin, etc., as defined herein.

### Screen Printing Machine and Improvements

According to another particular embodiment, the invention supplies a humidifier module for a screen printing machine, this printing machine now being adapted for printing baking paper (before or after perforation if necessary), said module comprising: an ultrasonic humidifier equipped with a perforated-nozzle pipe system for creating a controlled humid environment in the printing zone. This makes it possible to maintain the necessary ink viscosity for continuous printing.

The following examples are presented with the aim of providing full disclosure and description of the invention for people who are not familiar with the field connected with the invention, so that they can implement and use the invention. The examples are not intended to limit the scope of what the inventors regard as their inventions, they do not represent all or the only experiments conducted. Great effort has been expended to ensure the accuracy of the figures presented (e.g. quantities, temperature, etc.), but experimental errors or deviations might have crept in. Unless stated otherwise, parts are parts by weight, molecular weight corresponds to the average molecular weight, temperatures are in degrees Celsius and the pressure is at, or close to, atmospheric pressure.

### EXAMPLES

### Example 1

### Printing on Carrier Medium

The paste of edible ink is preferably deposited on the carrier medium by a screen printing process. Printing may also be carried out by offset printing or digital printing.

After a drying time under radiant heat, the baking paper called “carrier medium” is cut according to the customer's requirements.

### Example 2

### Humidifying System Integrated with the Printing Machine

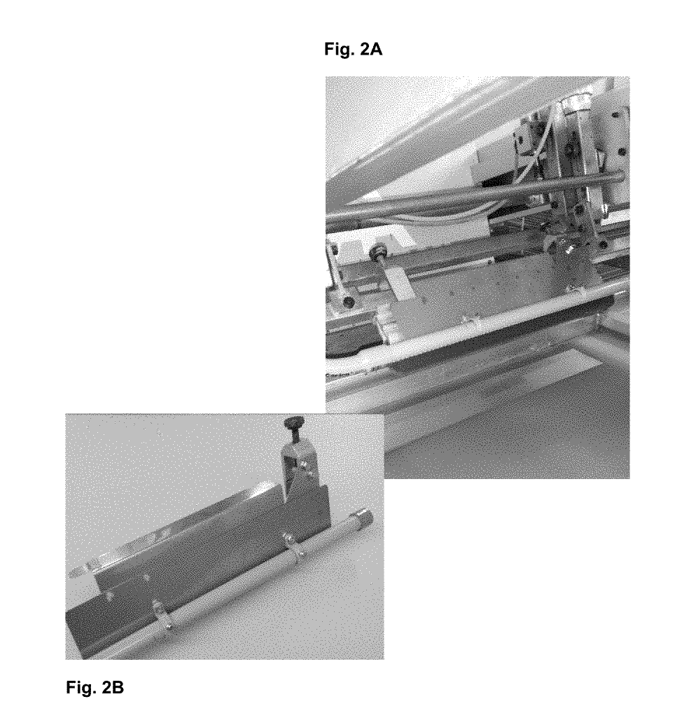

FIG. 2 shows a humidifying system integrated with a screen printing machine so that the ink paste retains the viscosity necessary for suitable printing.

Briefly, the system comprises an ultrasonic humidifier as well as a perforated-nozzle pipe system that makes it possible to create a controlled humid environment in the printing zone.

### Example 3

### Flexible Carrier Media

### Baking Paper

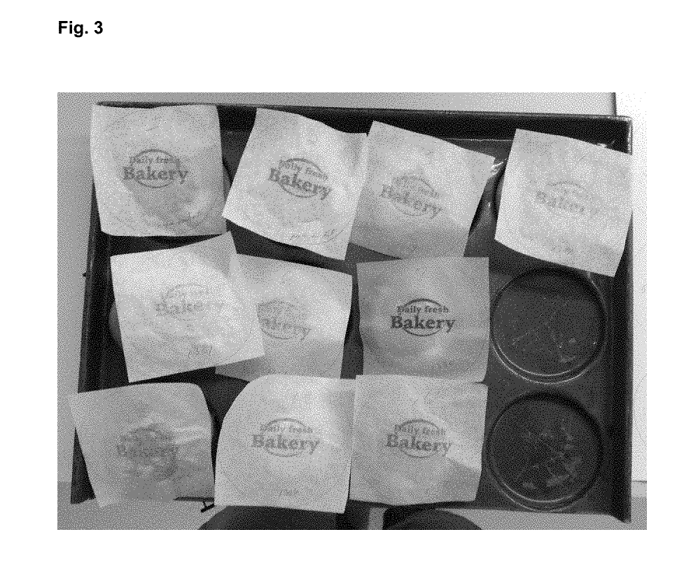

After conducting tests on several types of baking paper, we adopted baking paper with a minimum of silicone (FIG. 3) paper 24# BLEACHED GREASEPROOF C2S CODE 1309, manufactured by Glassine Canada Inc., with ingredients complying with the FDA (section 21 CFR 176,30, substances used in the manufacture of paper and cardboard products used for purposes of food packaging with respect to the ingredients of paper in contact with aqueous and oily foodstuffs and 21 CFR 176,180 contact with dry foodstuffs).

### Perforation of the Flexible Carrier Medium:

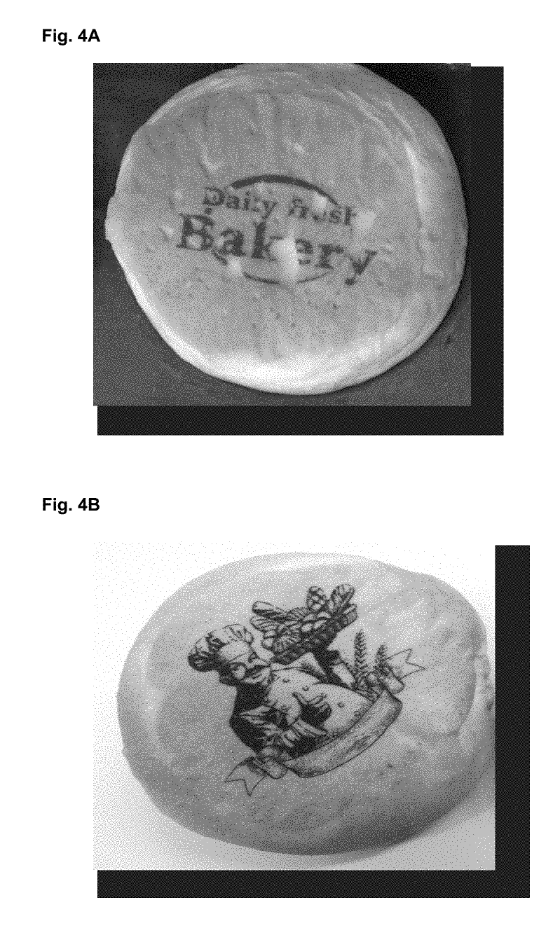

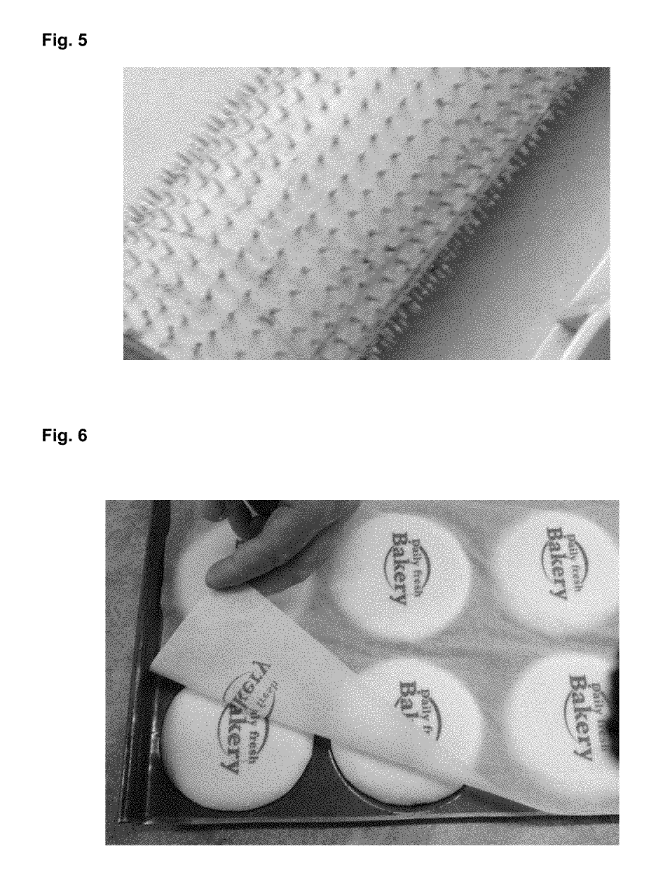

However, after several transfer tests that were not optimal (FIG. 4A), we developed a system for perforating the carrier medium (FIG. 4B). The baking paper is passed over a cylinder with needles (FIG. 5).

Perforation allows:
the paper to follow the shape and adhere to the surface of the food dough, which eliminates marks from the paper on the dough and holes in the bread;
heat to circulate under the paper, allowing uniform coloration of the bread and transfer in +/−1 minute;
gases (air bubbles) that form during baking to escape, so that the transfer is identical to what is on the carrier medium;
high print quality, constancy, controlled quality, and very few rejects.

The perforations allow heat and air to circulate under the paper. As a result, the image is 100% transferred (FIG. 4B), in contrast to unperforated paper, with which the image is ±50% transferred (FIG. 4A).

The quality of transfer is based on perforated or porous paper, which can be modified according to certain parameters. More particularly, the perforation system (FIG. 5) comprises a cylinder with needles positioned diagonally; backing for the needles made of natural rubber with hardness of 40, with perforations spaced 3 mm apart arranged in a quincunx, the holes forming an opening from 0.3 mm to 0.6 mm. It was found that these perforations gave rise to porosity of 62.5 cm³/15 s (air).

### Example 4

### Method of Applying the Carrier Medium

### Thermal Cycle Before Cooking:

The carrier medium is deposited on moistened dough after shaping, with or without yeast, and it is subjected to a cold thermal cycle (deep-freezing or freezing). The carrier medium is then removed before baking in the oven (FIG. 6).

### Thermal Cycle After Cooking:

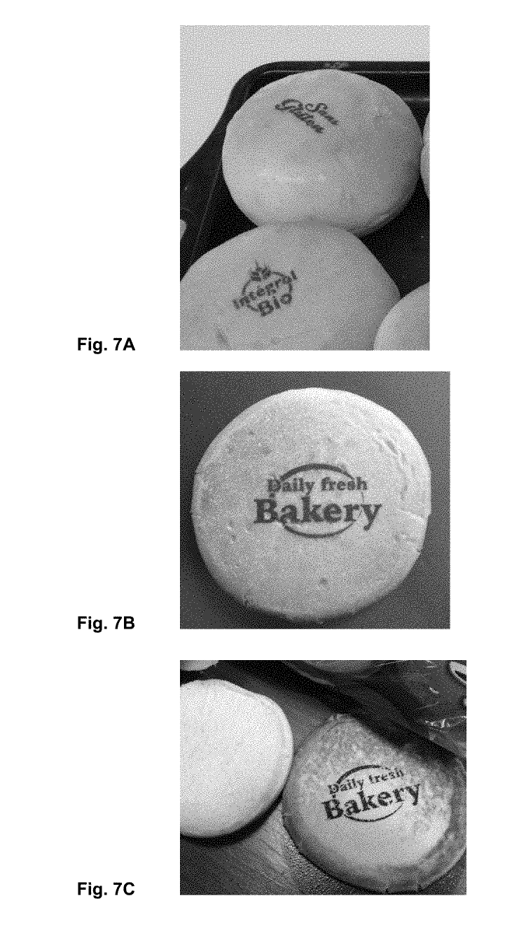

Hot: the carrier medium is deposited on the baked dough moistened with milk (FIG. 7A). Pressure is applied using a weight (i.e. a hot cast-iron plate) to create a hot thermal cycle (FIGS. 7B (bread roll) and 7C (half roll)).

### Thermal Cycle During Baking

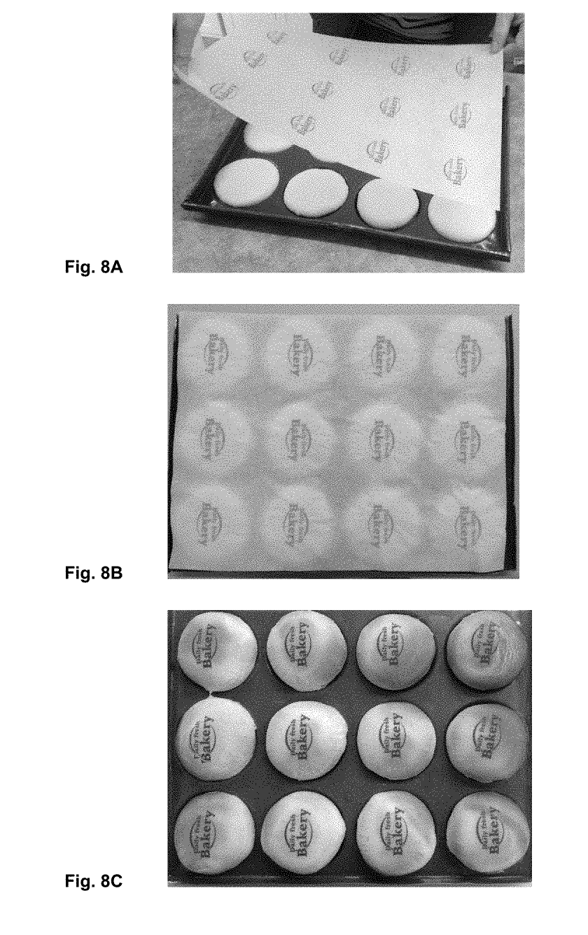

After shaping, and removal from the oven, the carrier medium is deposited on moist dough with yeast or on moist dough without yeast that is moist and sticky, before baking (FIG. 8A-B).

The carrier medium is then removed at the start after +/−1 minute baking, or else at the end of baking in the oven (FIG. 8C).

These methods of application may be carried out in the traditional manner (manual application) or mechanically on a production line.

### Example 5

### Alternative Methods

Alternatively, on pastry items or on pastries made with sweetened dough, the carrier medium may be applied on the shaped dough after shaping or the carrier medium may be deposited on dough without yeast. The dough must be moist (i.e. not wetted, but sticky) before baking. The carrier medium is then removed at the end of baking in the oven.

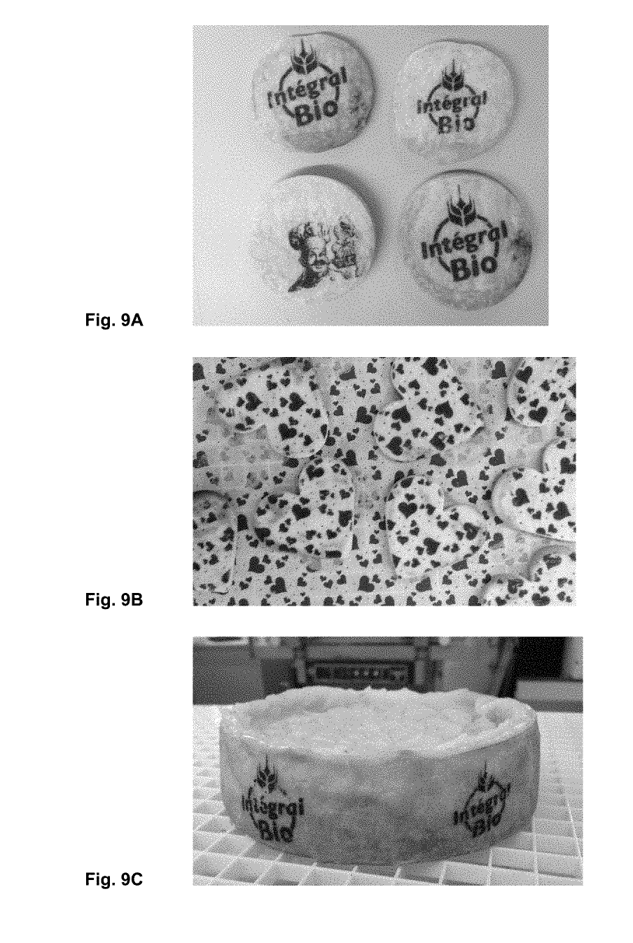

The shaped salted dough is deposited on the carrier medium (FIG. 9A). The shaped sugared dough is deposited on the carrier medium (FIG. 9B). The carrier medium is applied around the shaped dough (FIG. 9C).

### Example 6

### Ink Recipe

| LIQUID PHASE | wt % |
|---|---|
| Water | 37.5% |
| Trimoline ® | 8.3% |
| (microcrystalline | |
| invert sugar | |
| syrup), | |
| Glycerin | 9.4% |
| Polysorbate 60/80 | 1.8% |

| FATTY PHASE | wt % |
|---|---|
| Canola oil | 3.7% |
| Coconut oil | 1.8% |
| Lecithin | 0.2% |

| DRY INGREDIENTS | wt % |
|---|---|
| Tapioca flour | 10.2% |
| Solid corn syrup | 4.6% |
| Confectioner's | 2.8% |
| sugar | |
| Microcrystalline | 3.7% |
| cellulose | |
| Gum acacia | 0.05% |
| Modified starch | 0.5% |
| Citric acid | 0.5% |
| Potassium sorbate | 0.01% |
| Sodium alginate | 0.5% |
| Rice starch | 7% |
| Milk protein | 0.1% |
| Food dye | 6% |
| Calcium carbonate | 1% |

### Protocol for Preparing the Paste

A—Mix all the dry ingredients with a blender.
B—Mix all the liquid ingredients heated to 50° C. with a blender.
C—Mix the fatty phase at 40° C. to create an emulsion, adding it to the liquid paste using a homogenizer of the Rotor-Stator type.
D—Add preparation C to the dry paste A and mix with a blender for 2 to 3 minutes at medium speed.

### Example 7

### Transfer Onto Various Food Items

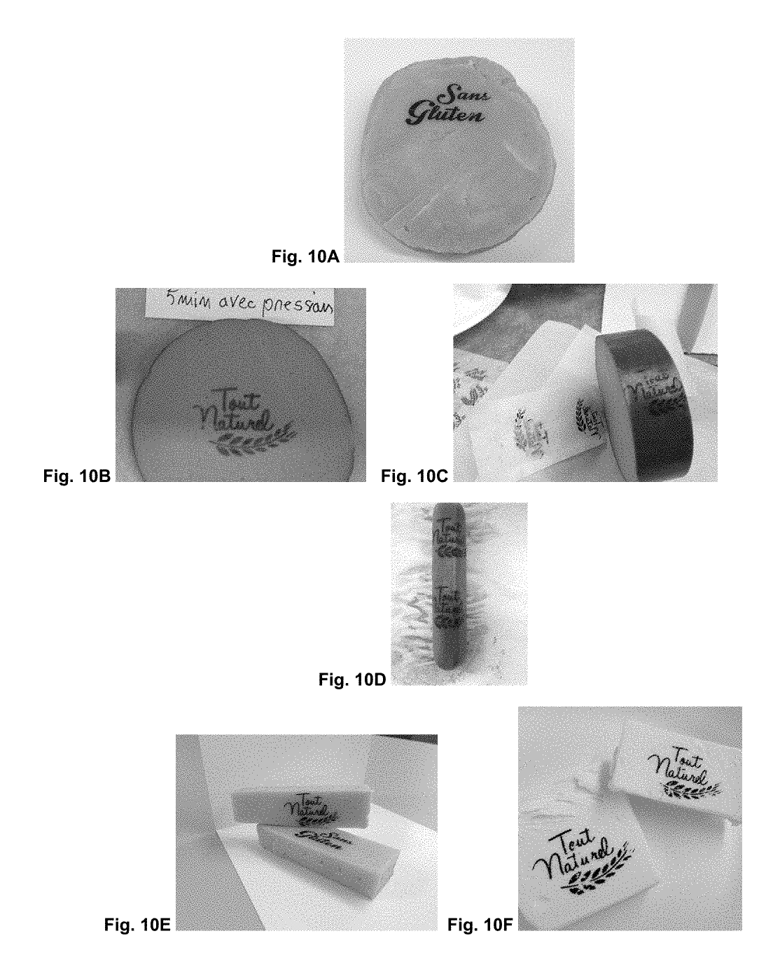

FIG. 10 illustrates transfer onto cold foodstuffs at the temperature of the refrigerator (approx. 4° C.). Transfer is effected on: sugared tart pastry (A), sausages (B, C), smoked sausage (D), cheese (E), butter (F) and jelly (not shown). Note that there is still a thermal cycle (i.e. gradient) since the foodstuffs are cold and the printed carrier medium is at room temperature.

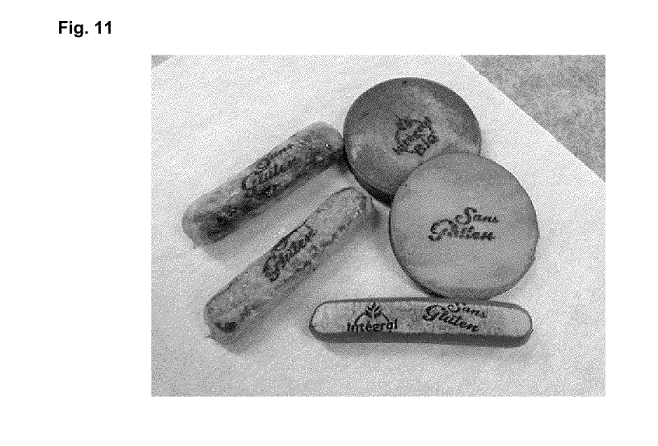

Thermal cycle in the frying pan: transfer is effected onto fresh and smoked sausage (not shown). Thermal cycle on a plate: transfer is effected onto fresh and smoked sausage, and sausages (FIG. 11).

The present invention has been described with particular applications found or proposed by the inventor so as to include especially those preferred for implementing the invention. Those skilled in the art connected with the invention will find that in light of the present disclosure, several modifications or changes may be made to the particular applications presented as examples while remaining within the scope of the invention. All such modifications must be understood as forming part of the scope established by the appended claims.

All the publications or patent applications cited in the present description are incorporated herein by reference as if each of them taken individually has been specifically and individually stated to be incorporated by reference.

1. An edible ink comprising approximately: from 30% to 45% of water; from 8% to 12% of glycerin; from 3% to 6% of vegetable oil; from 8% to 12% of flour; from 3% to 4.5% of microcrystalline cellulose; from 6% to 8% of starch; and from 0.8% to 1.2% of calcium carbonate.

2. The ink as claimed in claim 1, comprising approximately: from 30% to 45% of water; from 8% to 12% of glycerin; from 3% to 4.5% of canola oil; from 1 to 2% of coconut oil; from 8% to 12% of tapioca flour; from 3% to 4.5% of microcrystalline cellulose; from 6% to 8% of rice starch; and from 0.8% to 1.2% of calcium carbonate.

3. The ink as claimed in claim 1, comprising approximately: from 30 to 45% of water, from 7 to 10% of Trimoline®, from 8 to 12% of glycerin; from 1 to 2% of potassium polysorbate; 3-4.5% of canola oil, 1-2% of coconut oil, 0.1-0.3% of soybean lecithin, 8-12% of tapioca flour, 4-5.5% of solid corn syrup, 2-3% of confectioner's sugar, 3-4.5% of microcrystalline cellulose, 0.01-0.05% of gum acacia, 0.2-0.4% of modified starch, 0.2-0.4% of citric acid, 0.05-0.15% of potassium sorbate, 0.2-0.3% of alginate, 6-8% of rice starch, 0.8-1.2% of calcium carbonate, 0.8-1.2% of milk protein, and 5-7% of food dye.

4. A method for transferring a logo onto a food item comprising at least one moist surface, said method comprising the following steps:
a) obtaining a flexible carrier medium, printed on at least one face with an edible ink;
b) affixing said printed face of said carrier medium on said moist surface;
c) subjecting said carrier medium affixed to said surface to a thermal cycle; and
d) removing said carrier medium.

5. (canceled)

6. The method as claimed in claim 4, wherein said edible ink comprises approximately: from 30% to 45% of water; from 8% to 12% of glycerin; from 3% to 6% of vegetable oil; from 8% to 12% of flour; from 3% to 4.5% of microcrystalline cellulose; from 6% to 8% of starch; and from 0.8% to 1.2% of calcium carbonate.

7. The method as claimed in claim 4, wherein said thermal cycle is carried out hot or cold.

8. The method as claimed in claim 7, wherein said cold thermal cycle is effected by refrigeration, deep-freezing or freezing.

9. The method as claimed in claim 7, wherein the cold thermal cycle is carried out during or after: refrigeration, freezing or deep-freezing.

10. The method as claimed in claim 7, wherein said hot thermal cycle is carried out during cooking of the item or using a hot tool.

11. The method as claimed in claim 10, wherein the hot thermal cycle is carried out before, during or after cooking.

12. The method as claimed in claim 10, wherein said flexible carrier medium is also porous.

13. The method as claimed in claim 12, wherein said flexible, porous carrier medium is selected from: cloth, cheese-ripening paper, and perforated baking paper.

14. The method as claimed in claim 13, wherein said baking paper is greaseproof paper, heat-resistant film, or silicone-coated parchment paper.

15. The method as claimed in claim 12, wherein said carrier medium has a porosity of about 50 to 75 cm3/15 s.

16. A printing carrier medium for transferring a logo onto a moist food surface, said carrier medium essentially consisting of perforated baking paper, at least one side of said paper being suitable for printing with an edible ink, and for transferring said ink onto a moist food surface during a thermal cycle.

17. The carrier medium as claimed in claim 16, printed with an edible ink comprising approximately: from 30% to 45% of water; from 8% to 12% of glycerin; from 3% to 6% of vegetable oil; from 8% to 12% of flour; from 3% to 4.5% of microcrystalline cellulose; from 6% to 8% of starch; and from 0.8% to 1.2% of calcium carbonate.

18-34. (canceled)
